(19) United States
(12) Patent Application Publication
(10) Pub. No.: US 2012/0295087 A1
(43) Pub. Date: Nov. 22, 2012

(54) METHOD FOR PRODUCING A STRUCTURED TCO-PROTECTIVE COATING

(76) Inventors: Anne Gierens, Aachen (DE); Rudolf Metzger, Alsdorf (DE); Emmanuelle Peter, Aix-En-Provence (FR); Gerard Ruitenberg, Alsdorf (DE)

(21) Appl. No.: 13/513,184

(22) PCT Filed: Feb. 8, 2011
(86) PCT No.: PCT/EP11/51772

§ 371 Date: May 31, 2012

(30) Foreign Application Priority Data
Feb. 10, 2010 (EP) 10153198.6

(51) Int. Cl. H01B 13/00; B32B 7/02

(52) U.S. Cl. 428/216; 216/13

(57) ABSTRACT

A method for producing a coated glass substrate is described. The method includes depositing a TCO (thin conductive oxide) layer with a layer thickness of 100 nm to 1000 nm on a glass substrate, depositing an inert top coating, comprising Al₂O₃, SiO₂, Si₃N₄, and/or mixtures thereof, with an average layer thickness of 0.5 nm to 5 nm on the TCO layer, and heating the glass substrate at 550° C. to 800° C. and then etching in an acid, with the inert top coating not removed before the etching.

The invention relates to a method for producing a structured TCO-protective coating, a substrate with a structured TCO-protective coating, and their use in solar cells and/or displays.

Substrates provided with optically transparent, electrically conductive coatings such as TCOs (transparent conductive oxides) are used in many areas of photovoltaics and display technology. They serve as contact electrodes in solar cells, organic light emitting diodes (OLEDs), touchscreens, and displays. Key figures in the characterization of TCOs are the highest possible optical transparency and high electrical conductivity. These properties make TCOs interesting, particularly as light-permeable electrodes for solar modules, and form, together with the rear electrode, buffer layers, antireflective layers, and the actual photoactive semiconductors, the basic structure of the solar cell.

Photovoltaic layer systems for the direct conversion of sunlight into electrical energy are known. The materials and the arrangement of the layers are coordinated such that incident radiation is converted directly into electrical current by one or a plurality of semiconducting layers with the highest possible radiation yield. Photovoltaic and extensive-area layer systems are referred to as solar cells.

Solar cells include, in all cases, semiconductor material. Solar cells which require carrier substrates to provide adequate mechanical strength are referred to as thin-film solar cells. Due to the physical properties and the technological handling qualities, thin-film systems with amorphous, micromorphous, or polycrystalline silicon, cadmium telluride (CdTe), gallium-arsenide (GaAs), or copper indium (gallium)-sulfur/selenide (CI(G)S) are particularly suited for solar cells.

Known carrier substrates for thin-film solar cells include inorganic glass, polymers, or metal alloys and can be designed as rigid plates or flexible films depending on layer thickness and material properties. Due to the widely available carrier substrates and a simple monolithic integration, large-area arrangements of thin-film solar cells can be produced cost-effectively.

Thin-film solar cells have, however, compared to solar cells with crystalline or multicrystalline silicon, a lower radiation yield and lower electrical efficiency. Thin-film solar cells based on Cu(In, Ga)(S, Se)₂ have electrical efficiencies that are roughly comparable to multicrystalline silicon solar cells. CI(G)S-thin-film solar cells require a buffer layer between a typically p-conducting CI(G)S-absorber and a typically n-conducting front electrode, which usually contains zinc oxide (ZnO). The buffer layer can effect an electronic adaptation between the absorber material and the front electrode. The buffer layer contains, for example, a cadmium-sulfur compound. A rear electrode with, for example, molybdenum, is deposited directly on carrier substrates.

An electrical circuit of a plurality of solar cells is referred to as a photovoltaic module or a solar module. The circuit of solar cells is durably protected from environmental influences in known weather-resistant superstructures. Usually, low-iron soda lime glasses and adhesion-promoting polymer films are connected to the solar cells to form a weather-resistant photovoltaic module. The photovoltaic modules can be integrated via connection boxes into a circuit of a plurality of photovoltaic modules. The circuit of photovoltaic modules is connected to the public supply network or to an independent energy supply via known power electronics.

The creation of optically transparent, electrically conductive coatings, such as, for instance, transparent conductive oxides (TCOs), generally necessitates deposition, for example, sputtering, at high temperatures. However, at the same time, the high temperatures require expensively heated sputtering systems and expensive process control. One possible solution for this problem is deposition at room temperature and subsequent heating at higher temperatures.

However, heating at elevated temperatures in an oxygen-containing atmosphere causes additional oxidation of the upper TCO-layers. At the same time, this oxidation reduces the electrical conductivity of the transparent conductive oxides. To reduce oxidation, an additional inert layer, e.g., Si₃N₄, can be applied. Before further structuring of the TCO-surface, this inert layer must be removed. This removal of the inert layer makes additional, very complex process steps necessary. Moreover, the TCO-layer can also be damaged by the removal of the inert layer.

EP 1 056 136 B1 discloses a substrate for a solar cell that comprises at least one glass sheet, a first and second undercoating film, and a conductive film. The first undercoating film contains at least one of the components tin oxide, titanium oxide, indium oxide, or zinc oxide.

US2008/0314442 A1 discloses a transparent substrate with an optically transparent electrode consisting of at least two layers. The first transparent, electrically conductive layer contains an undoped mineral oxide, such as tin oxide, for instance. The second transparent, electrically conductive layer contains, in contrast, a doped mineral oxide.

US 2009/0084439 A1 discloses a solar cell with TCO-layers. The solar cell contains a structure comprising a substrate, a buffer layer, a first TCO-layer, a plurality of silicon layers, a second TCO-layer, and an antireflective layer.

DE 10 2007 024 986 A1 discloses a temperature-resistant TCO-layer and a method for production thereof. The TCO-layer is provided with a transparent and conductive protective coating that allows higher processing conditions. The protective coating contains preferably amorphous silicon and, in the later course of processing, crystalline silicon.

US 2007/0029186 A1 discloses a method for producing a coated glass substrate. The method comprises the deposition of a TCO-film at room temperature on a glass substrate and deposition of a protective coating on the TCO-film. The coated glass substrate is then tempered.

The object of the invention is to provide a method for production of a TCO-coated substrate that allows a defined TCO-deposition (transparent conductive oxide) at low temperatures and subsequent TCO-surface structuring without a substantial reduction in electrical conductivity.

The object of the present invention is accomplished according to the invention by means of a method for producing a coated, reflection-reduced substrate according to the independent claim 1. Preferred embodiments emerge from the dependent claims.

The object of the invention is further accomplished by means of a coated substrate and its use in accordance with other coordinated claims.

The method according to the invention for producing a coated substrate comprises, in a first step, the deposition of a TCO-layer in a layer thickness of 100 nm to 1000 nm on a glass substrate. The TCO-layer is preferably applied on the glass substrate by CVD (chemical vapor deposition), CLD (chemical liquid deposition), and/or PVD (physical vapor deposition). The TCO-layer is, particularly preferably, applied on the glass substrate by sputtering and/or magnetron sputtering. The application occurs, preferably, at room temperature and the glass substrate is preferably not further heated except by the coating process. In a second step, an inert top coating, comprising at least one of the compounds Al₂O₃, SiO₂, Si₃N₄, and/or mixtures thereof, with an average layer thickness of 0.5 nm to 5 nm, is deposited. The deposition occurs, as described above, preferably by sputtering; the inert top coating is formed starting from crystallization centers distributed over the surface. These crystallization centers are formed from local clusters of the inert top coating. Starting from these local clusters, the inert top coating grows on the TCO-layer. Since the inert top coating is applied only to an average layer thickness of 0.5 nm to 5 nm, the inert top coating is not homogeneously distributed over the entire TCO-layer, but, instead, forms regions with a layer thickness of 0.5 nm to 5 nm and regions outside the clusters, which have no inert top coating or less than 0.5 nm In the following step, the coated substrate is heated and/or tempered at 550° C. to 800° C. and then etched in an acid. The etching occurs through spraying and/or dipping; the substrate is preferably completely dipped into the acid. The inert top coating is not removed before the etching.

The heating and/or tempering occurs, preferably, for 30 s to 240 s. In the context of the invention, the term “tempering” describes heating or holding at a constant temperature.

The heating occurs, preferably, in an oxygen-containing atmosphere with at least 10 vol.-% O₂, preferably at least 15 vol.-% O₂.

The deposition of the TCO-layer and/or the inert top coating occurs, preferably, by means of PVD (physical vapor deposition) or CVD (chemical vapor deposition), particularly preferably by means of sputtering and especially preferably by means of cathode sputtering and/or magnetron sputtering. The deposition occurs preferably at room temperature.

The inert top coating is preferably deposited in a layer thickness from 1 nm to 4 nm.

The etching occurs preferably with an inorganic and/or organic acid, particularly preferably HF, H₂SiF₆, (SiO₂)ₘ*nH₂O, HCl, H₂SO₄, H₃PO₄, HNO₃, CF₃COOH, CCl₃COOH, HCOOH, CH₃COOH, and/or mixtures thereof.

The invention further comprises a coated substrate. The coated substrate comprises, preferably glass or polymer. A TCO-layer with a layer thickness of 100 nm to 1000 nm is applied on the substrate. A diffusion barrier layer made of Si₃N₄, SiO₂ and/or Al₂O₃ with a thickness of 30 nm to 100 nm is preferably applied between the glass substrate and the TCO-layer. The TCO-layer is provided on the side turned away from the substrate with an inert coating layer containing Al₂O₃, SiO₂, Si₃N₄, and/or mixtures thereof, with an average layer thickness of 0.5 nm to 5 nm The inert top coating covers preferably 20% to 80% of the surface of the TCO-layer. In the context of the invention, the term “covers” refers to regions of the inert topcoat with layer thicknesses of >0.5 nm The inert top coating both protects the TCO-layer from oxidation during production and, simultaneously, acts, by means of the succession of regions with an inert top coating and regions without an inert top coating on the surface of the TCO-layer, as an antireflection layer.

The TCO-layer contains preferably tin-doped indium oxide (ITO), aluminum-doped zinc oxide (AZO), fluorine-doped tin oxide (FTO, SnO₂:F), antimony-doped tin oxide (ATO, SnO₂:Sb), aluminum, zinc, indium, gallium, silver, gold, tin, tungsten, copper, cadmium, niobium, strontium, silicon, zinc, selenium, and/or mixtures or alloys thereof.

The inert top coating preferably has an average layer thickness of 2 nm to 4 nm

The inert top coating contains preferably silicon, carbon, germanium, Si₃N₄, and/or mixtures thereof.

The substrate contains preferably flat glass (float glass), quartz glass, borosilicate glass, soda lime glass, and/or composites thereof.

The TCO-layer has preferably a sheet resistance of <20Ω/square, preferably <15Ω/square, particularly preferably <10Ω/square.

The invention further comprises the use of the coated substrate in solar cells and/or displays, preferably thin-film solar cells, as contact electrodes with high optical transparency and electrical conductivity.

In the following, the invention is explained in detail with reference to drawings as well as an example and a comparative example. The drawings are purely schematic and not true to scale. The drawings in no way restrict the invention.

They depict:

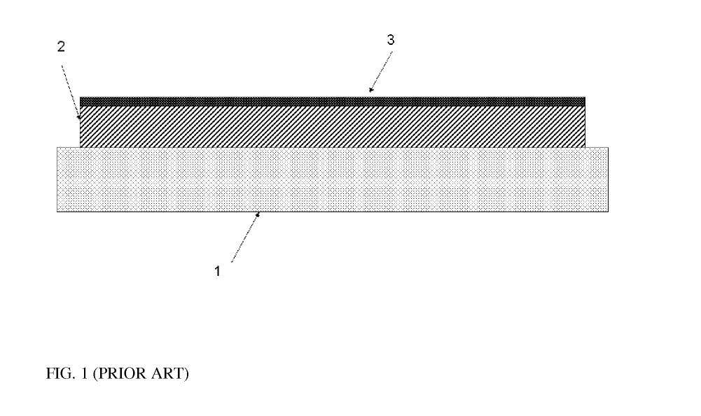

FIG. 1 a cross-section of a coated substrate of the prior art and

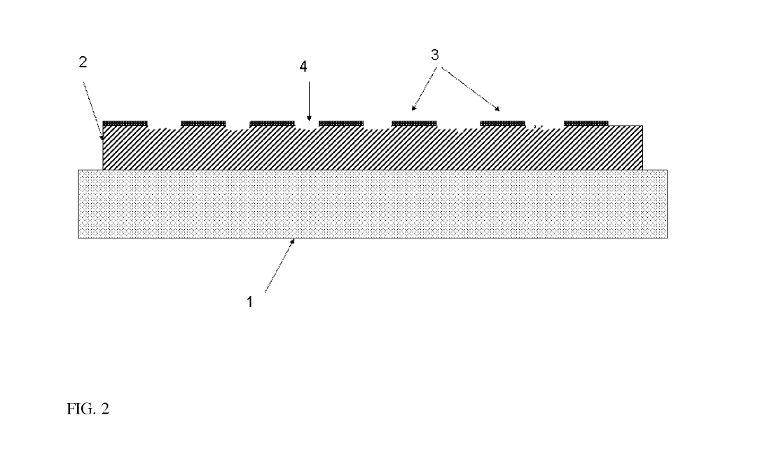

FIG. 2 a cross-section of the substrate according to the invention.

FIG. 1 depicts a cross-section of the coated substrate of the prior art. A TCO-layer (2) is located on a substrate (1) made of glass or polymer. The TCO-layer (2) is covered by a inert top coating (3).

FIG. 2 depicts a cross-section of the substrate according to the invention. A TCO-layer (2) is located on a substrate (1) made of glass or polymer. The TCO-layer (2) is covered by a non-closed inert top coating (3). The regions without or with only a small layer thickness of the inert top coating (4) are accessible to etching procedures with an acid or a base and act, together with the inert top coating (3), as an antireflection layer.

In the following, the invention is explained in detail with reference to an example and a comparative example.

A coated glass substrate (A) according to the invention and a glass substrate (B) of the prior art were produced. The deposition occurred by sputtering, as described, for example, in US2007/0029186 A1. The glass substrate (A) coated according to the invention had the following layer structure: glass (3 mm/(1)/Si₃N₄ (50 nm/diffusion bather layer)/aluminum-doped zinc oxide (1000 nm)(2)/Si₃N₄ (2 nm)(3). The glass substrate (B) of the prior art had the following layer structure: glass (3 mm)(1)/Si₃N₄ (50 nm)/aluminum-doped zinc oxide (1000 nm)(2). Both glass substrates (A) and (B) were heated in air for 75 s at 650° C. The cooled glass substrates (A) and (B) were then dipped for 75 s in 0.5 wt.-% HCl and rinsed with distilled water. With both glass substrates (A) and (B), the sheet resistance R_{V} before and R_{N} after heating and acid treatment were measured, and the absorption and haze were determined after the acid treatment. The results are presented in Table 1.

TABLE 1
Sheet resistance R_{V} before and R_{N} after heating, absorption,
and haze of the glass substrate (A) according to the invention
and the glass substrate (B) of the prior art.

| | R_{V} | R_{N} | Absorption | Haze |
|---|---|---|---|---|
| | [Ω/square] | [Ω/square] | [%] | [%] |
| Glass substrate (A) | 14 | 6 | 4.3 | 21 |
| Glass substrate (B) | 14 | 12 | 4.6 | 22 |

It can be discerned from Table 1 that the sheet resistance R_{N} after heating and treatment with acid clearly drops in the glass substrate (A) according to the invention by 57% in comparison with the glass substrate (B) of the prior art at 14%. The values of absorption and haze remain substantially constant, such that these properties of the TCO-coating are not degraded by the thinner inert top coating according to the invention. Instead, the method for producing a coated glass substrate according to the invention allows a clear reduction of the sheet resistance. These results were surprising and not obvious.

### REFERENCE CHARACTERS:

1 Glass substrate

2 TCO-layer

3 Inert top coating, and

4 Region without inert top coating.

1. A method for producing a coated glass substrate, the method comprising:
depositing a TCO (thin conductive oxide) layer with a layer thickness of 100 nm to 1000 nm on a glass substrate,
depositing an inert top coating, comprising Al₂O₃, SiO₂, Si₃N₄, and/or mixtures thereof, with an average layer thickness of 0.5 nm to 5 nm on the TCO layer, and
heating the glass substrate at 550° C. to 800° C. and then etehed etching in an acid, with the inert top coating not removed before the etching.

2. The method according to claim 1, wherein the glass substrate is heated in an oxygen-containing atmosphere with at least 10 vol. % O₂. least 15 vol. %

3. The method according to claim 1, wherein the TCO layer and/or the inert top coating are deposited by means of PVD (physical vapor deposition) or CVD (chemical vapor deposition).

4. The method according to claim 1, wherein the TCO layer and/or the inert top coating are deposited at room temperature.

5. The method according to claim 1, wherein the inert top coating is deposited with a layer thickness of 1 nm to 4 nm.

6. The method according to claim 1, wherein the etching takes place with an inorganic and/or organic acid.

7. A coated glass substrate, comprising:
a glass substrate,
a TCO layer with a layer thickness of 100 nm to 1000 nm on the glass substrate, and
an inert top coating, comprising Al₂O₃, SiO₂, Si₃N₄, and/or mixtures thereof, in an average layer thickness of 0.5 nm to 5 nm on the TCO layer.

8. The coated glass substrate according to claim 7, wherein the TCO layer comprises tin-doped indium oxide (ITO), aluminum-doped zinc oxide (AZO), fluorine-doped tin oxide (FTO, SnO₂:F), antimony-doped tin oxide (ATO, SnO₂:Sb), and/or mixtures or alloys thereof.

9. The coated glass substrate according to claim 7, wherein the inert top coating has an average layer thickness of 1 nm to 4 nm.

10. A coated glass substrate according to claim 7, wherein the inert top coating covers 20% to 80% of the surface of the TCO layer.

11. The coated glass substrate according to claim 7, wherein the glass substrate comprises flat glass (float glass), quartz glass, borosilicate glass, soda lime glass, and/or composites thereof.

12. The coated glass substrate according to claim 7, wherein the TCO layer has a sheet resistance of <20 Ω/square.

13. A method comprising:
using the coated substrate according to claim 7 in solar cells, electrochromic glazings, and/or displays.

14. The method according to claim 1, wherein the glass substrate is heated in an oxygen-containing atmosphere with at least 15 vol. % O₂.

15. The method according to claim 1, wherein the TCO layer and/or the inert top coating is deposited by means of sputtering.

16. The method according to claim 1, wherein the TCO layer and/or the inert top coating is deposited by means of cathode sputtering and magnetron sputtering.

17. The method according to claim 1, wherein the etching takes place with HF, H₂SiF₆, (SiO₂)ₘ*nH₂O, HCl, H₂SO₄, H₃PO₄, HNO₃, CF₃COOH, CCl₃COOH, HCOOH, and/or CH₃COOH.

18. The coated glass substrate according to claim 7, wherein the TCO layer has a sheet resistance of <15 Ω/square.

19. The coated glass substrate according to claim 7, wherein the TCO layer has a sheet resistance of <10 Ω/square.

20. The method of claim 13, wherein the solar cells are thin-film solar cells.
